(19) United States
(12) Patent Application Publication
(10) Pub. No.: US 2024/0414693 A1
(43) Pub. Date: Dec. 12, 2024

(54) METHODS FOR ESTABLISHING COMMUNICATION BETWEEN A REMOTE WIRELESS DEVICE AND A NETWORK NOCE, RELATED WIRELESS DEVICES AND RELATED NETWORK NODE

(71) Applicant: Sony Group Corporation, Tokyo (JP)

(72) Inventors: Rickard LJUNG, Helsingborg (SE); Torgny PALENIUS, Barsebäck (SE); Nafiseh Seyed MAZLOUM, Lund (SE); Anders BERGGREN, Lund (SE); Basuki PRIYANTO, Lund (SE)

(21) Appl. No.: 18/700,258

(22) PCT Filed: Oct. 21, 2022
(86) PCT No.: PCT/EP2022/079381

§ 371 Date: Apr. 10, 2024

(30) Foreign Application Priority Data
Oct. 22, 2021 (SE) 2151296-7

(51) Int. Cl. H04W 68/02; H04W 72/40

(52) U.S. Cl. CPC H04W 68/02; H04W 72/40

(57) ABSTRACT

A method is disclosed, performed by a relay wireless device (WD), for establishing communication between a remote WD and a network node. The relay WD has an established sidelink connection with the remote WD. The method comprises communicating, between the relay WD and the network node, at least one relay paging response configuration message configuring the remote WD with a plurality of alternative response paths that can be used when responding to paging. The alternative response paths comprise responding directly to the network node or responding via the relay WD. The method comprises monitoring a paging occasion for a paging message of the remote WD from the network node. The method comprises, upon detecting the paging message from the network node, activating the sidelink connection with the remote WD. The method comprises, upon receiving the paging message, relaying the paging response received from the remote WD to the network node.

The present disclosure pertains to the field of wireless communications. The present disclosure relates to methods for establishing communication between a remote WD, a related remote wireless device, a related relay wireless device, and a related network node.

### BACKGROUND

Within 3^{rd} Generation Partnership Project (3GPP) there is work ongoing on supporting New Radio (NR) devices with reduced capability (redcap). Reduced capability may also imply a device with so-called low-complexity implementation. NR Redcap devices may continuously be evolved, such as the low-complexity devices in a form of power restricted Wireless Devices (WDs) which, for example due to constrained battery capacity or similar, may not be able to communicate with the network or other devices during a certain period when a stored energy in the battery drops below a certain level.

If a WD is located close to an edge of a coverage area of a network node, such as at the edge of a cell of the network node, the WD may be required to use a higher transceiver power for receiving and/or transmitting signals from and/or to the network node. When the WD is located at an edge of the coverage area the WD detect a very low signal strength from the network node. Receiving signals with low signal strength may be power consuming for the WD and transmitting signals to the network node may in such case be even more power consuming than receiving the signals. A WD located remotely from the network node, such as at the edge of the coverage area of the network node, may thus drain its battery at a higher rate than a WD located closer to the network node. For a power restricted WD this may lead to the WD running out of power before it can finish its communication with the network node.

### SUMMARY

Accordingly, there is a need for devices and methods for establishing communication between a remote WD and a network node, which may mitigate, alleviate, or address the shortcomings existing and may provide a more power efficient communication between the WD and the network node.

A method is disclosed, performed by a relay wireless device (WD), for establishing communication between a remote WD and a network node. The relay WD has an established sidelink connection with the remote WD. The method comprises communicating, between the relay WD and the network node, at least one relay paging response configuration message configuring the remote WD with a plurality of alternative response paths that can be used when responding to paging. The alternative response paths comprise responding directly to the network node or responding via the relay WD. The method comprises monitoring a paging occasion for a paging message of the remote WD from the network node. The method comprises, upon detecting the paging message from the network node, activating the sidelink connection with the remote WD. The method comprises, upon receiving the paging message, relaying the paging response received from the remote WD to the network node.

Further, a relay WD is provided, the device comprising memory circuitry, processor circuitry, and a wireless interface. The relay wireless device is configured to perform any of the methods disclosed herein for the relay WD.

It is an advantage of the present disclosure that the relay WD can be configured by the network to monitor paging occasions of the remote WD and/or to receive a Dedicated Radio Resource Control (RRC) message from the network, comprising a paging message intended for the remote WD, in order to trigger a reactivation of the sidelink to support the paged remote WD with its communication. By reactivating the sidelink, the remote WD can communicate with the network via the relay WD, without having to perform a complete link establishment of the sidelink connection (for example using a sidelink discovery procedure). When the remote WD is paged from the network, the remote WD can thus respond to the paging message via the relay WD to the network and may receive corresponding data via the relay WD. This reduces the power consumption of the remote WD, since the paging response can be sent with a lower power to the relay node, instead of following legacy high-power demanding Random Access Channel (RACH) procedure to the network node. A radio transceiver of the remote WD for sidelink reception and/or transmission can further be configured for lower power consumption, for example by being configured to have a lower bandwidth. This allows the remote WD to be transmitting with a reduced Tx power. Correspondingly, the remote WD may reduce its power consumption, which is especially beneficial for power constrained WDs having a limited amount of stored energy.

A method is disclosed, performed by a remote WD, for establishing communication between the remote WD and a network node. The remote WD is camping on the network and has an established sidelink connection with a relay WD. The method comprises communicating, between the remote WD and the network node, at least one relay paging response configuration message configuring the remote WD with a plurality of alternative response paths that can be used when responding to paging, wherein the alternative response paths comprise responding directly to the network node or responding via the relay WD. The method comprises monitoring for a paging message directly from the network node. The method comprises, upon detecting the paging message from the network node, transmitting the paging response to be relayed to the network node to the relay WD over the sidelink connection.

Further, a remote WD is provided, the remote WD comprising memory circuitry, processor circuitry, and a wireless interface. The remote wireless device is configured to perform any of the methods disclosed herein for the remote WD.

It is an advantage of the present disclosure that the remote WD can communicate with the network via the relay WD. When the remote WD is paged from the network, the remote WD can thus respond to the paging message via the relay WD and may receive corresponding data via the relay WD. This reduces the power consumption of the remote WD, since the paging response can be sent with a lower power to the relay node, instead of transmitting response following legacy high-power demanding RACH procedure to the network node. A radio transceiver of the remote WD for sidelink reception and/or transmission can further be configured for lower power consumption, for example by being configured to have a lower bandwidth. This allows the remote WD to be transmitting with a reduced Tx power. Correspondingly, the remote WD may reduce its power consumption, which is especially beneficial for power constrained WDs having a limited amount of stored energy. In one or more examples, the WD may receive the paging message via the relay WD in shorter receiving time, which may allow the remote WD to save energy for paging reception.

A method is disclosed, performed in a network node, for establishing communication between a remote WD and the network node. The remote WD is camping on the network. The method comprises communicating one or more relay paging response configuration messages configuring the remote WD with a plurality of alternative response paths that can be used when responding to paging. The alternative response paths comprise responding directly to the network node or responding via the relay WD. The method comprises transmitting the paging message associated with the remote WD. The method comprises receiving, from the relay WD, the paging response associated with the remote WD.

Further, a network node is provided, the network node comprising memory circuitry, processor circuitry, and a wireless interface, wherein the network node is configured to perform any of the methods disclosed herein for the network node.

It is an advantage of the present disclosure that the network node can configure the relay WD to monitor paging occasions for the remote WD, in order to trigger a reactivation of a sidelink to support the paged remote WD with its communication with the network node. By activating the sidelink the remote WD can communicate with the network via the relay WD. When the remote WD is paged from the network, the remote WD can thus respond to the paging message via the relay WD to the network and may receive corresponding data via the relay WD. This reduces the power consumption of the remote WD, since the paging response can be sent with a lower power to the relay node. A radio transceiver of the remote WD for sidelink reception and/or transmission can further be configured for lower power consumption, for example by being configured to have a lower bandwidth. This allows the remote WD to be transmitting with a reduced Tx power. Correspondingly, the remote WD may reduce its power consumption, which is especially beneficial for power constrained WDs having a limited amount of stored energy.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example remote wireless device and relay wireless device according to this disclosure,

FIG. 2 is a diagram illustrating an example scenario in which the methods according to this disclosure may be applied,

FIG. 3 is a signaling diagram illustrating an example message exchange for establishing communication between a remote WD and a network node according to this disclosure,

FIG. 4A-B is a flow-chart illustrating an example method, performed in a relay WD, for establishing communication between a remote WD and a network node according to this disclosure,

FIG. 5A-B is a flow-chart illustrating an example method, performed in a remote WD, for establishing communication between the remote WD and a network node,

FIG. 6 is a flow-chart illustrating an example method, performed in a network node, for establishing communication between a remote WD and the network node,

FIG. 7 is a block diagram illustrating an example relay wireless device according to this disclosure,

FIG. 8 is a block diagram illustrating an example remote wireless device according to this disclosure, and

FIG. 9 is a block diagram illustrating an example network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may be referred to as an operation mode wherein a data transmission can be communicated e.g., between the wireless device (WD) and a network node or between the WD and another WD. A connected mode may be referred to as an operation state wherein a radio transmitter and/or a radio receiver is activated for such communication. A connected mode may be referred to as an operation state wherein the WD is synchronized time-wise and/or frequency-wise e.g., by a determined timing advance parameter for the communication. Furthermore, a connected mode may be referred to as an operation state wherein transfer of unicast data to/from the WD can be performed. In certain communication systems, a connected mode may be referred to as a radio resource control (RRC) state. In various examples, an active state may be a RRC connected state and/or an RRC active state. However, a connected mode may be an active period within another RRC state.

The dormant mode is a mode where the WD has no active connection with the network node and/or with a second WD via sidelink. A dormant mode may be seen as an inactive mode of the WD. A dormant mode may be seen as a mode where the WD is unsynchronized with a timing of a network or with a second WD. In one or many examples, the WD may in a dormant mode not have a valid timing advance information with respect to the network. A dormant mode may be seen as a mode where the WD may not be able to receive dedicated signaling. A dormant mode may be seen as a mode where closed loop power control is inactivated or suspended. Dormant mode may comprise RRC idle mode, RRC suspend, RRC inactive mode and/or a WD power save mode in which the WD is not monitoring paging and/or Discontinuous Reception (DRX) mode in which the WD monitors paging periodically. For example, the WD may be in dormant mode when the connection with the network node and/or with the second WD has been paused, released, temporarily deactivated and/or suspended.

A WD attached to or camping at a cell of a 3GPP radio network node, such as over the Uu interface, may use a Discontinuous Reception (DRX) configuration in any DRX mode, such as Idle state, Inactive state or Connected mode DRX. The DRX configuration defines a DRX cycle comprising an ON time, such as an ON duration, in which the WD wakes up to listen for messages. The DRX cycle may further comprise an off time, such as an idle period, in which the WD may go to sleep, such as enter a power saving mode or the dormant mode. The ON time of the DRX cycle may herein be referred to as a DRX occasion. In the power saving mode, the WD may turn off its transceiver in order to reduce its power consumption.

The figures are schematic and simplified for clarity, and they merely show details which aid understanding the disclosure, while other details have been left out. Throughout, the same reference numerals are used for identical or corresponding parts.

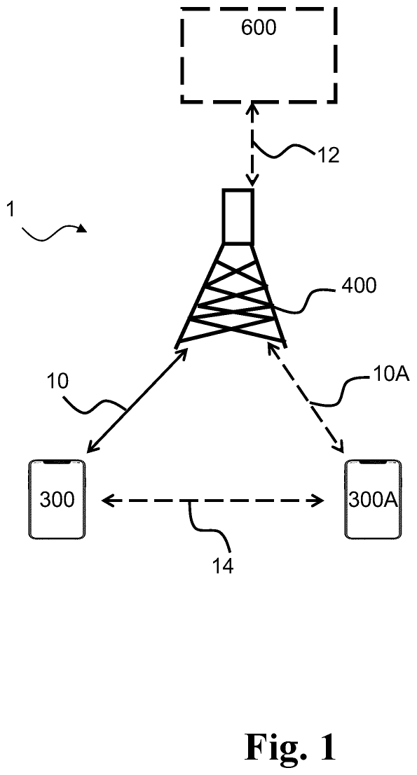

FIG. 1 is a diagram illustrating an example wireless communication system 1 comprising an example network node 400, an example first wireless device 300, an example second wireless device 300A, and an example core network (CN) node 600 according to this disclosure.

As discussed in detail herein, the present disclosure relates to a wireless communication system 1 comprising a cellular system, for example, a 3GPP wireless communication system. The wireless communication system 1 comprises one or more wireless device(s) 300, 300A, a network node 400 and/or a core network (CN) node 600.

A network node disclosed herein may refer to a CN node and/or a radio access network node operating in the radio access network, such as a base station, an evolved Node B, eNB, gNB in NR. In one or more examples, the RAN node is a functional unit which may be distributed in several physical units.

A CN node disclosed herein refers to a network node operating in the core network, such as in the Evolved Packet Core Network, EPC, and/or a 5G Core Network, 5GC. Examples of CN nodes in EPC include a Mobility Management Entity, MME, and/or in 5GC an Access and Mobility management Function, AMF.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless devices 300, 300A may be configured to communicate with the network node 400 via a wireless link (or radio access link) 10, 10A, such as via a 3GPP Uu interface.

The wireless devices 300, 300A may, in one or more examples, be configured to communicate with each other via a wireless link 14, such as a side-link, which is also known as a 3GPP PC5 interface. In one or more examples such wireless link 14 may use a different radio protocol than the radio protocol used for the wireless link 10, 10A. In one or more examples such wireless link 14 may operate on a different frequency band than the wireless link 10, 10A. In one or more examples such wireless link 14 may operate on an unlicensed/shared frequency band.

In one or more example wireless communication systems 1, the first WD 300 may communicate, or may be configured to communicate, with the network node 400 via the second WD 300A. In other words, the second WD 300A may relay transmissions between the first WD 300 and the network node 400. The second WD 300A may be referred to as a relay WD when the second WD 300A is configured to relay transmissions, or may be configured to relay transmissions, between the first WD 300 and the network node 400 the second WD 300A may be referred to as a relay WD. The first WD 300 may be referred to as a remote WD when the first WD 300 is configured to communicate with the network node 400 via the second WD 300A the first WD 300 may be referred to as a remote WD. However, in one or more examples any WD capable of sidelink communication may be a relay WD, such as dependent on the relative position of the WD in the cell of the network node. In one or more example methods, the WD 300 may thus be a relay node for relaying communication from the WD 300A. In one or more example methods, a single physical WD may act both as a remote WD and a relay WD. In one or more example methods, a single WD may act both as a remote WD and a relay WD at the same time, for example when the WD is part of a chain of a plurality of WDs operating in sidelink and the WD relays communication from one remote WD to another relay WD communicating with the network node.

According to one or more example methods herein, a remote WD, such as a power constrained WD, can utilize a relay WD discovery process to identify a suitable relay link, such as a sidelink, for potential future communications. The relay link may upon detection and/or discovery be put in a dormant or power saving mode.

According to one or more example methods herein, a relay WD can be configured by the network to monitor paging occasions for one or more other WDs, such as one or more remote WDs. The purpose of this function may not be to respond to those paging events, but instead to trigger a re-activation of the of the earlier detected relay link (PC5 interface) in order to support the paged remote WD with its communication.

A paging occasion may be seen as a re-occurring time period (or physical time/frequency resource) where one or more wireless devices may be paged by the network node. For example, a paging occasion involves the wireless device waking up according to a WD identity (ID), such as a UE ID, to read Paging Radio Network Temporary Identifier (P-RNTI) on a Physical Downlink Control Channel (PDCCH) monitoring occasion. According to 3GPP TS 38.304 v. 16 section 7.1 a paging occasion (PO) is a set of Physical Downlink Control Channel (PDCCH) monitoring occasions and can consist of multiple time slots (e.g., a subframe or an Orthogonal Frequency Division multiplexing (OFDM) symbol) where paging Downlink Control Information (DCI) can be sent (see e.g., 3GPP TS 38.213). One Paging Frame (PF) is one Radio Frame and may contain one or multiple PO(s) or starting point of a PO.

According to one or more example methods herein, when a remote WD is paged, such as receives a paging message, from the network for Downlink (DL) data, the remote WD may respond to the paging message via the relay WD, such as via the relay link, to the network. The remote WD may receive the corresponding data via the relay WD and the sidelink. As described above, this can save power at the remote WD since Uplink (UL) feedback, such as the paging response, can be sent with a lower power and the radio for sidelink reception/transmission can be configured to have lower bandwidth, thereby reducing the power consumption of the remote WD. The remote WD may be transmitting with a low Transmit (Tx) power over the sidelink. The remote WD may also use power efficient idle or inactive states developed in NR (such as defined in 3GPP TS 38.300 v16.6.0), LTE (such as defined in 3GPP TS 36.300 v16.6.0) or other corresponding RATs, such as RRC Idle or Inactive states, over the direct link, such as the Uu interface.

The paging message may, in one or more example methods, comprise a paging Downlink Control Information (DCI) received in a Physical Downlink Control Channel (PDCCH) followed by a paging content in a Physical Downlink Shared Channel (PDSCH). In one or more examples, the paging message may comprise a paging early indication message, transmitted prior to a paging DCI. In one or more example methods, the paging message includes the UE ID.

According to one or more example methods herein, the remote WD, when the remote WD is in coverage of the sidelink connection with the relay node, may remain in RRC Idle state on the Uu interface towards the RAN node, even after it has been paged over the Uu interface. Instead of using the Uu interface, all the following transmissions and receptions made by the remote WD may be done via the relay WD using the sidelink connection. In one or more example methods, the remote WD may enter RRC connected state on the Uu interface in case the received signal strength on the Uu interface is above a certain threshold, such as above a signal strength threshold.

According to one or more example methods herein, the remote WD may not be required to monitor the sidelink unless it is paged on the Uu interface or if there is an ongoing communication with the network. According to one or more examples, when there is no ongoing communication active in neither direct link nor sidelink, the remote WD may not be required to monitor the sidelink for further communication or discovery signals. It may only monitor paging on the Uu interface in this case.

The Network, such as the RAN node (such as a gNB) and the core network, on which the remote WD is camping may be aware and/or may be informed that the remote WD may respond to paging via the relay WD. The paging response may thereby be transmitted to a RAN node in the same network, such as the same RAN node or another RAN node on the same or on another carrier frequency.

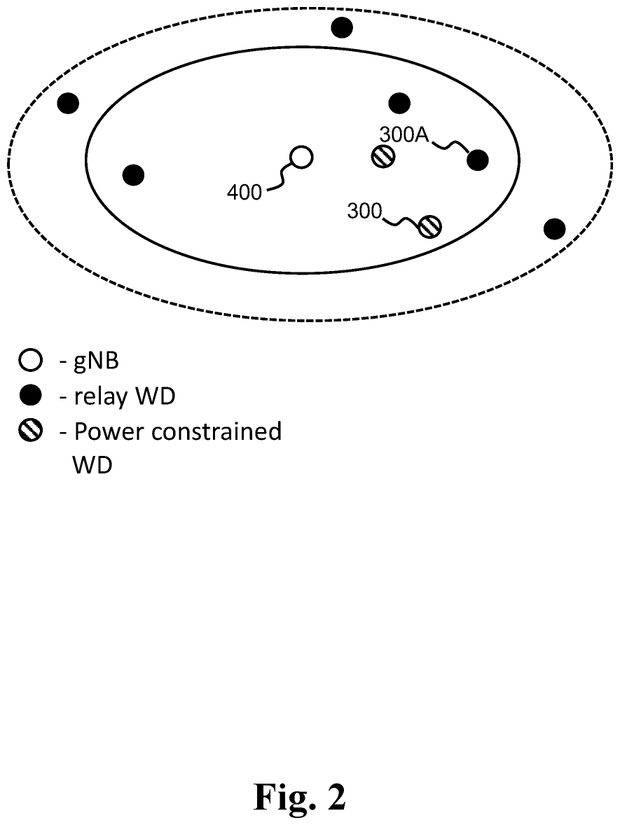

FIG. 2 discloses an example usage scenario for when the methods according to this disclosure may be beneficial. In FIG. 2 a plurality of WDs 300, 300A is located within a coverage area of a network node 400, such as a gNB, within a wireless communications network. In FIG. 2, a coverage area for area for legacy WDs is indicated by the solid circle and an extended coverage area for e.g., Enhanced Machine-Type Communication (eMTC) and/or Narrowband Internet of Things (NB-IoT) WDs is indicated by the dashed circle. Some WDs arranged close to the edge of the coverage area may detect a low signal strength from the gNB. In FIG. 2, the WD detecting a low signal strength from the gNB may be a power constrained WD 300 located close to the edge of the coverage area for legacy WDs. Receiving signals with low signal strength may be power consuming for the WD and transmitting signals to the gNB may, in such case, be even more power consuming. According to this disclosure, the power constrained WD 300 may save energy by avoiding transmitting signals directly to the gNB 400 and may instead transmit signals to the network node via a relay WD 300A, such as via the sidelink.

A power constrained WD may herein be one or more of:
a low-power WD with limited capability and thereby with limited functionality compared to legacy/existing WDs. For instance, WDs equipped with ultra-low power wake-up receivers, and
a WD having full capability and functionality in terms of fulfilling coverage requirement but with limited battery size. A WD having full capability and functionality may be a WD that satisfies the current standardized Rx sensitivity and Tx power for a NR UE in 3GPP TS 38.101-1.

In one or more example methods, the methods disclosed herein may be applied in one or more example scenarios, such as where:
the power constrained WD operates within a network with relatively long distance between the power constrained WD and a serving RAN node, such as a gNB. This may occur in a network having large distances between gNBs. For frequency range 1 (FR1) a large distance may be a couple of kilometres. For frequency range 2 (FR2) millimetre wave, a large distance may be hundreds of metres.
the power constrained WD and the serving RAN node are close in distance geographically, but the WD is inside a basement or in another environment where the radio signal may be weak,
the power constrained WD has a limited sensitivity compared to other WDs, such as legacy WDs, and
the power constrained WD and the serving RAN node are relatively close in distance geographically (in-coverage), but the power constrained WD is relatively even closer to a relay WD than to a serving RAN node.

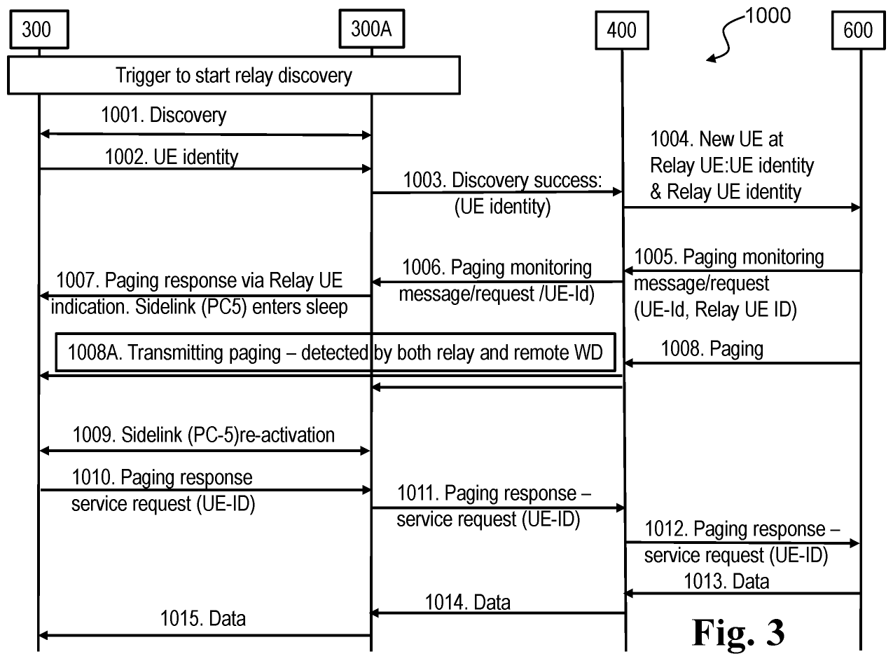

FIG. 3 is signaling diagram showing an example message exchange between a remote WD 300, a relay WD 300A, a RAN node 400, such as a gNB and a core network node 600 according to one or more example methods disclosed herein.

The CN node 600 may communicate with the remote WD 300 and/or with the relay WD 300A via the RAN node 400. The remote WD 300 and/or the relay WD 300A may communicate over an air interface, either with the RAN node 400, or with the CN node 600 via the RAN node 400. Traffic in terms of CN signaling or user data traffic from or to the CN node 600 may be carried transparently through the RAN node 400.

The remote WD 300, such as a power constrained WD, may be registered to the network and may be camping on the network, such as may be in a dormant mode, such as in RRC IDLE state towards the network.

The remote WD, such as the power constrained WD, may upon camping on the network, such as on a cell of the network, indicate a preference to use sidelink communication, for example if a received signal strength from the RAN node 400 is equal to or below a certain threshold, such as equal to or below a signal strength threshold.

As described in the prior art, one possibility is that the remote WD can communicate with the network node over a direct link, such as over the Uu interface. The direct link is a link between the network node and the remote WD without any intermediate nodes and/or wireless devices, such as without a relay WD. The remote WD may indicate, using for example a UE capability or another indicator, to the network, a preference of the remote WD to use sidelink for a selected set of services. This signaling may be done to initiate a search for a candidate sidelink capable WD to communicate with. Such signal may be transmitted by the WD in case the detected received signal strength from the RAN node is equal to or below the threshold, such as the signal strength threshold.

Once the remote WD 300, such as the power constrained WD, is camping on a cell, the remote WD 300 may initiate a discovery procedure 1001, such as a sidelink relay discovery process, to discover and set up a sidelink connection with a second WD capable of acting as a relay WD for relaying communication between the remote WD and the network. It may be seen that the remote WD 300 is not yet acting as a remote WD at this stage and may prior to establishing the sidelink to the relay WD be referred to as a WD. This step 1001 may be triggered from the remote WD 300, based on for example the threshold of the received signal strength from the RAN node 400. In other words, the remote WD 300 may not need to discover a relay WD 300A if the signal strength of the RAN node 400 signal is sufficient, such as above the threshold, such as above the signal strength threshold. The remote WD 300 may, in one or more example methods, use the above-mentioned indicator signaling from the remote WD 300 to indicate its preference to the network, such as to the RAN node 400 and/or the CN node 600, to use a relay WD 300A for relaying the communication between the remote WD 300 and the RAN node 400, and/or the CN node 600. In other words, in one or more example methods, the remote WD 300 may use the above-mentioned indicator signaling to indicate its preference to respond to paging via the relay WD. The sidelink relay discovery procedure may in one or more example methods, be regularly triggered or initiated by the network, or by one or more relay WDs 300A within the cell. The discovery procedure may follow the currently discussed Release 17 functionality in 3GPP for discovery of sidelink capable UEs. In one or more example methods, the discovery procedure may comprise discovery signal transmissions and/or discovery signal detection.

In a legacy network, a UE camping in a cell would not benefit from detecting a suitable relay WD 300A. However, according to the current disclosure the remote WD 300 may benefit from using a relay WD 300A and/or may be required to communicate with the RAN node 400 via a relay WD 300A to save energy. Therefore, detecting a relay WD 300A enables future communication by the remote WD 300 using the detected relay WD 300A, and therefore the remote WD 300, such as the power constrained WD, may initiate the discovery procedure upon camping in a cell to identify a relay WD 300A to utilize for upcoming communication.

The relay WD 300A transmits a UE ID 1003, such as a temporary UE ID, utilized within the network to identify that particular remote WD 300 to the RAN node 400, in order for the network to be aware of which remote WDs 300 the relay WD 300A has detected in its proximity and/or has established a PC-5 connection with.

The RAN node 400 may transmit a message to the CN node 600 indicating 1004 that a new remote WD 300 is available via the relay WD 300A. The message may indicate the ID, such as the UE ID, of the remote WD 300 and/or the relay WD 300A.

According to one or more examples, the network, such as the RAN node 400, transmits a paging monitoring message 1005 to the relay WD 300A comprising paging occasions configured for the remote WD 300 in addition to the relay WDs 300A own paging monitoring. In one or more examples the paging monitoring message may be a paging monitoring instruction instructing the relay WD 300A to monitor the paging occasions configured for the remote WD 300. In one or more example methods the paging monitoring message may be sent in response to a request from the relay WD 300A to the network to monitor the paging occasions of the remote WD 300. The remote WD 300 may still be expected to monitor its paging occasions as well. The instruction to monitor paging occasions configured for the remote WD 300 may be transmitted in a paging monitoring request message. The instruction to monitor paging occasions may in one or more example methods be configured as part of a modified control signaling mechanism, such as by transmitting an updated RRC configuration to the relay WD 300A. In one or more example methods, the instruction to monitor paging occasions can be transmitted using a downlink layer 1 control signaling, such as Physical Downlink Control Channel (PDCCH) signaling.

To listen to potential paging for the remote WD 300 the relay WD 300A can determine the timing for the paging occasions of the remote WD 300. Since the timing for paging occasions is based on the UE ID, such as the temporary UE ID, used in the cell, the signaling from the network, such as from the RAN node 400, may comprise the UE ID. In one or more example methods, the UE ID, such as the temporary UE ID, of the remote WD 300 may be received from the remote WD 300. If the network would request the relay WD 300A to monitor multiple paging occasions (such as for multiple remote WDs), this signaling request may include more than one ID. The instruction to monitor paging occasions configured for the remote WD 300 may in one or more example methods be triggered by the finding of a relay WD 300A that the remote WD 300 can camp on. The remote WD 300 may append an indication of its paging preferences in 1002, which may be forwarded to the network by the remote WD 300A via 1003. In case the relay WD is in RRC-Connected mode, the paging monitoring request may be conveyed to the relay WD 300A in an RRC message.

The relay WD 300A may indicate to the remote WD 300 that it may respond to paging via the relay WD 300A, such as via the sidelink.

Once a suitable relay WD 300A has been discovered and/or the remote WD 300 has initiated 1002 a contact with the relay WD 300A, such as has established a sidelink connection with the relay WD 300A, the WD 300 may receive an indication 1007 from the relay WD 300A that the remote WD 300 may respond to a paging message via the relay WD 300A. In response to the indication 1007, the sidelink between the remote WD 300 and the relay WD 300A can be put into a dormant mode or similar power saving operation. In the dormant mode and/or in the power saving operation, the remote WD 300 and/or the relay WD 300A are not monitoring the sidelink unless being paged by the network, such as by the RAN node 400 and/or the CN node 600.

Both the remote WD 300 and the relay WD 300A may, such as after the indication 1007 has been received and the sidelink has been put into dormant mode or similar power saving operation, monitor paging 1008, targeted to, such as intended for, the remote WD 300. A WD may hear, such as listen to, a paging of another WD even if the paging is a dedicated paging to the other WD. Therefore, the relay WD may monitor the paging targeted to the remote WD. Once the network pages the remote WD, both the relay WD 300A as well as the remote WD 300 are made aware of data communication needs 1008A for the remote WD 300. This is in contrast to legacy operation, where the remote WD 300, upon receiving the paging, would be required to start transmissions to the RAN node 400 directly in order to initiate the paging response. In other words, in legacy operation the normal behavior of the WD is to send the paging response on the same link as the paging was received on, in this case over the direct link, such as the Uu interface. In legacy wireless communication systems, a legacy WD could only request a relay discovery and setup after a paging response via random access procedure over the Uu interface as well as a finalized connection procedure due to the data that caused the paging, such as via the direct link to the RAN node 400. A legacy WD would thus have to use a large amount of its power to respond to the paging and to finalize the connection procedure before it could switch to communicating via the sidelink, which may lead to a power constrained WD running out of power before the sidelink connection has been setup.

Upon detecting the paging for the remote WD 300, the relay WD 300A and/or the remote WD 300 re-activates 1009 the sidelink communication on the PC5 interface between the remote WD 300 and the relay WD 300A.

Upon detecting the paging for the remote WD 300, the remote WD 300 transmits 1010 the paging response, such as a service request, to the network via the relay WD, using the sidelink communication on the already identified PC5 interface for the paging response. In one or more example methods, the remote WD 300 may select whether it transmits the paging response via the sidelink and/or via the direct link. The remote WD 300 may select whether it transmits the paging response via the sidelink and/or via the direct link based on the paging response configuration message. The relay WD 300A forwards the paging response 1011 to the RAN node 400. The RAN node 400 may send the paging response 1012 from the remote WD 300 to the CN node 600. The remote WD 300 may further use the sidelink connection for data communication 1013, 1014, 1015 between the remote WD 300 and the network, such as the RAN node 400 and the CN node 600.

Hence, upon detecting the paging of the remote WD 300, the two WDs, such as the remote WD 300 and the relay WD 300A, are both aware of the request by the network to communicate with the remote WD. The relay WD 300A uses this information to re-activate, such as enable the full operation of, the sidelink for the remote WD 300. The remote WD 300 may use the information to transmit the paging response (such as the service request) to the network via the relay WD 300A.

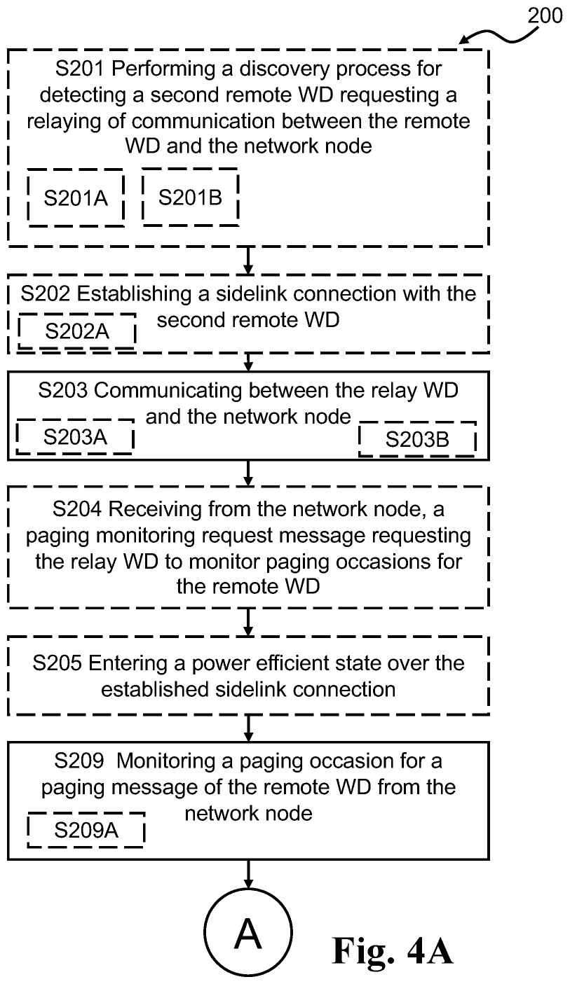

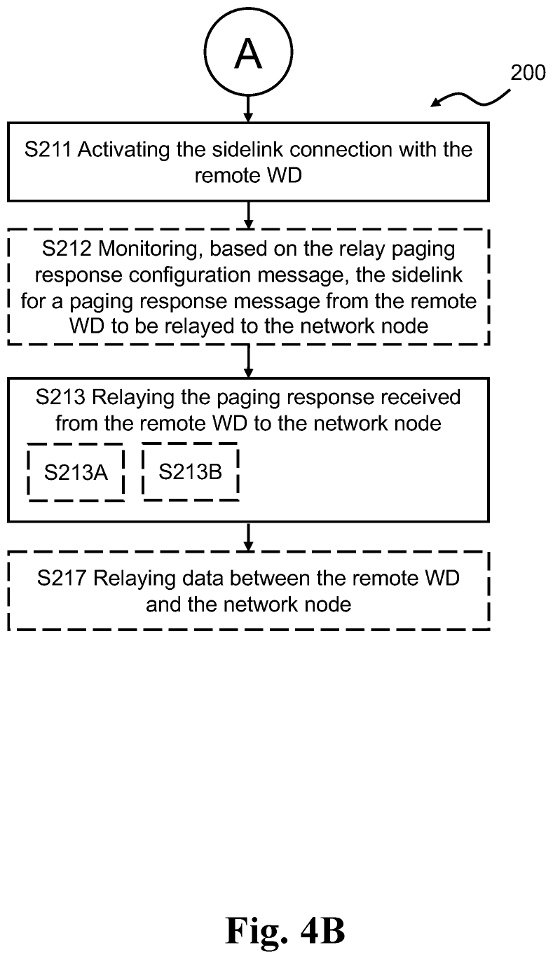

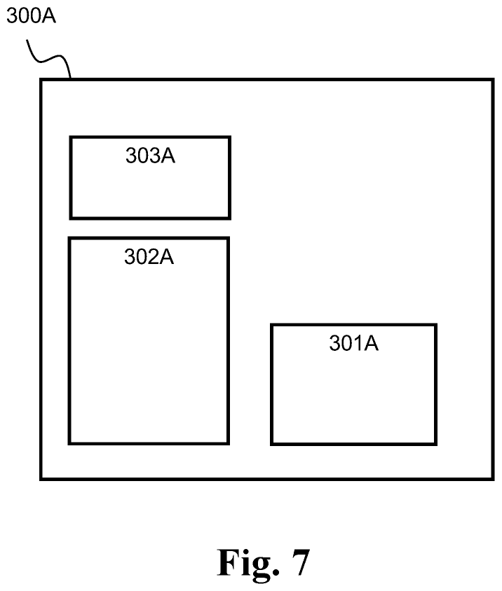

FIGS. 4A-B show a flow diagram of an example method 200, performed by a relay wireless device according to the disclosure, for establishing communication between a remote WD and a network node. The relay WD may be a WD disclosed herein being configured to relay communication from another WD, such as the wireless device 300A of FIG. 1, FIG. 2, FIG. 3, and FIG. 7, being configured to relay communications between the first WD 300 and the network node 400. The relay WD may have an established sidelink connection with the remote WD, such as via a PC5 interface. The relay WD may further have an established direct link connection, such as via a Uu interface, with the network node 400.

In one or more example methods, such as to establish the sidelink connection with the remote WD, the method comprises performing S201 a discovery process for detecting a remote WD requesting a relaying of communication between the remote WD and the network node. In one or more example methods, the method comprises, upon detecting a remote WD requesting a relaying of communication, establishing S202 a sidelink connection with the remote WD. In one or more example methods, performing S201 the discovery process comprises transmitting S201A, such as broadcasting, a first discovery signal. In one or more example methods, performing S201 the discovery process comprises receiving S201B a second discovery signal from the remote WD.

In one or more example methods, such as when the relay WD 300A has had an established sidelink connection with a first remote WD 300 and loses the sidelink connection with the first remote WD 300, the method may comprise performing S201A the discovery process for detecting a WD requesting a relaying of communication between the remote WD and the network node 400. The WD requesting a relaying of communication may be the first remote WD or any other WD. In one or more example methods, the method comprises, upon detecting a WD requesting a relaying of communication, establishing S202A a sidelink connection with the WD. In other words, the relay WD may perform the discovery process to reestablish the sidelink connection with the first remote WD or may establish a sidelink connection with another remote WD. The method 200 comprises communicating S203, between the relay WD and the network node, at least one relay paging response configuration message configuring the remote WD with a plurality of alternative response paths that can be used when responding to paging. In one or more example methods, the remote WD may select which alternative response path it is to use. The alternative response paths may comprise responding directly to the network node or responding via the relay WD. Communicating herein means transmitting signals to and/or receiving signals, either directly between two devices (without any intermediate relay devices) or indirectly via a third device, such as via a relay device. Configuring the remote WD may herein mean that the remote WD is provided with all the information and/or settings it needs to respond to paging using any of the alternative response paths. In other words, the at least one relay paging response configuration message may comprise the information and/or settings that the remote WD needs to respond to paging using either a direct link to the network node or responding via the relay WD. The relay paging response configuration message may comprise one or several messages transmitted in any direction and on different radio layers.

In one or more example methods, communicating S203 comprises transmitting S203A a capability message to the network node. In one or more example methods, the capability message comprises an indication indicating that the relay WD has an established sidelink connection with the remote WD. The indication may in one or more example methods, indicate that the remote WD may send the paging response over the sidelink and the relay WD. The indication may in one or more examples be an identifier (ID), such as a UE ID, identifying the remote WD to which the relay WD has an established sidelink. In one or more example methods, the at least one relay paging response configuration message, such as the capability message, comprises an identifier (ID), such as a UE ID, identifying the remote WD. In one or more example methods, the at least one relay paging response configuration message, such as the capability message, may comprise a temporary UE ID for identifying the remote WD. In other words, the relay WD may in one or more example methods transmit a temporary UE ID utilized within the network to identify the particular remote WD to the network node, to inform the network, such as the network node, about which remote WDs the relay WD has detected in its proximity, and/or which remote WDs the relay WD has established a sidelink connection, such as a PC5 connection, with.

In one or more example methods, communicating S203 comprises receiving S203B, from the network node, a paging monitoring request message requesting the relay WD to monitor paging occasions for the remote WD. In one or more example methods, the paging monitoring request message is indicative of configured paging occasions for the remote WD. In one or more example methods, the paging monitoring request may comprise an indication of a specific time and/or frequency resource of the paging occasion for the remote WD. In one or more example methods, the paging monitoring request message indicative of configured paging occasions for the remote WD comprises an identifier, ID, identifying the remote WD. In one or more example methods, the ID may be a temporary ID, such as a 5G-S-TMSI or a Global Unique Temporary Identifier (GUTI) identifying the remote WD in the network. The identifier identifying the remote WD may herein be referred to as a remote WD ID or a remote UE ID. The ID of the remote WD allows the relay WD to identify which remote WD it is requested to monitor paging for. In one or more example methods, the relay WD may calculate the paging occasion, such as the timing of the paging occasion, using the ID of the remote WD. To listen to potential paging for the remote WD the relay WD may have to determine a timing for the paging occasions for the remote WD. The timing for paging occasions can be based on the temporary UE ID used in the cell for the WD. The relay WD may thus use the ID of the remote WD, such as the temporary UE ID of the remote WD, to determine the timing of the paging occasions for the remote WD. In one or more examples, such as when the network requests the relay WD to monitor multiple paging occasions (such as for multiple remote WDs), the paging monitoring request may comprise more than one IDs, such as an ID for each of the remote WDs that the relay WD is requested to monitor. This step S203B corresponds to step S3003B of the network node.

In one or more example methods, receiving S203B the paging monitoring request comprises receiving the paging monitoring request message via one or more of wake-up signaling, Physical Downlink Control Chanel (PDCCH) signaling, and Radio Resource Control (RRC) signaling. The paging monitoring request may in one or more example methods be received as part of a modified control signaling mechanism, such as by receiving an updated RRC configuration from the network node.

In one or more example methods, the method comprises entering S205 a power efficient state over the established sidelink connection, after communicating S203 the at least one relay paging response configuration message. Entering a power efficient mode herein means that a sidelink is established between the relay WD and the remote WD, and that the relay WD is in a dormant mode, such as a non-active mode, on the sidelink. In the power efficient mode, the relay WD may perform sparse monitoring of the sidelink, such as to make sure that the sidelink is still established to the remote WD or to monitor for a wake-up signal or a discovery signal on the sidelink.

The method 200 comprises monitoring S209 a paging occasion for a paging message of the remote WD from the network node. In one or more example methods, monitoring S209 the paging occasion comprises monitoring a first paging occasion configured for the remote WD. In one or more example methods, monitoring S209 the paging occasion comprises monitoring a second paging occasion configured for the relay WD. In one or more example methods, the relay WD may monitor the direct link from the network node, such as the Uu interface, for the paging message of the remote WD from the network node.

In one or more example methods, monitoring S209 comprises evaluating S209A the paging message to determine whether the paging message is intended for the remote WD. If the relay WD only monitors the paging occasion of the remote WD, there is a risk of a false wake-up, where the relay WD may activate the sidelink unnecessary. The false wake-up may for example occur when a plurality of WDs are paged in the same paging occasion as the remote WD and a paging message transmitted in the paging occasion is not intended for the remote WD. To avoid that, the relay WD may evaluate the paging message, such as by opening the paging message and checking the paging record to see if the remote WD is part of that paging record. When the remote WD is part of the paging record the relay WD may determine that the paging message is intended for, such as associate with, the remote WD. When the paging message is not intended for the remote WD, the relay WD may proceed with monitoring of the paging occasions of the remote WD. In one or more example methods, such as when the paging message is received by the relay WD as a dedicated message, the relay WD may determine that the paging message is intended for the remote WD without opening the paging message.

The method 200 comprises, upon detecting the paging message from the network node, such as a paging message associated with the first WD and/or a paging message associated with the relay WD, activating S211 the sidelink connection with the remote WD. Activating S211 the sidelink connection allows the remote WD to send a paging response to the network node via the sidelink connection to the relay node, so that the relay node can relay the paging response to the network node. Activating S211 the sidelink connection with the remote WD may be based on the relay paging response configuration message.

In one or more example methods, the method comprises monitoring S212, based on the relay paging response configuration message, the sidelink for a paging response message from the remote WD to be relayed to the network node.

The method 200 comprises, upon receiving the paging message, relaying S213 a paging response received from the remote WD to the network node. In one or more example methods, relaying S213 may be based on the relay paging response configuration message. For example, the relay WD may monitor, based on the relay paging response configuration message, the sidelink connection for a paging response message from the remote WD. Upon receiving the paging response message from the remote WD via the sidelink, the relay WD may relay, such as forward, the paging response message to the network node. In one or more example methods, relaying S213 comprises receiving S213A the paging response to be relayed to the network node from the remote WD via the sidelink connection, such as via the PC5 interface. In one or more example methods, relaying S213 comprises transmitting S213B, to the network node, the paging response received from the remote WD, such as via the Uu interface.

In one or more example methods, the method comprises relaying S217 data between the remote WD and the network node. After the relay WD has relayed the paging response from the remote WD and the relay WD has relayed a response to the paging message from the remote WD to the network node, the relay WD may continue relaying data between the remote WD and the network node.

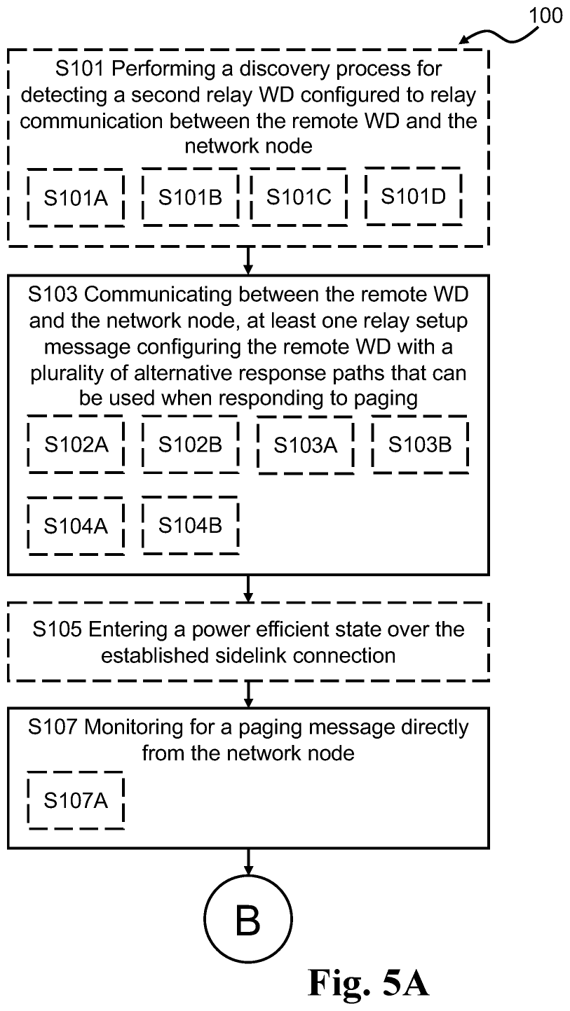

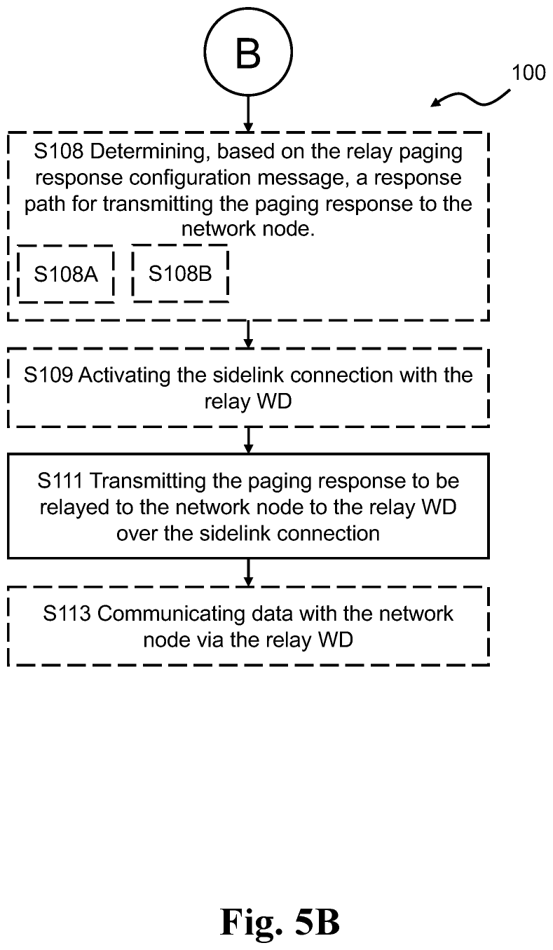

FIGS. 5A-B show a flow diagram of an example method 100, performed by a remote wireless device according to the disclosure, for establishing communication between the remote WD and a network node. The remote WD is the remote WD disclosed herein, such as remote WD 300 of FIGS. 1, 2, 3 and 8. The remote WD is camping on the network and has an established sidelink connection, such as via a PC5 interface, with a relay WD. Camping on the network herein refers to the remote WD being in dormant mode, such as in RRC IDLE state in relation to the network node and/or cell of the network node.

In one or more example methods, such as to establish the sidelink connection with the remote WD, the method comprises performing S101 a discovery process for detecting a relay WD configured to relay communication between the remote WD and the network node. In one or more example methods, the method comprises, upon detecting the relay WD, establishing S103 a sidelink connection with the relay WD.

In one or more example methods, performing the discovery process comprises transmitting S101A, such as broadcasting, a first discovery signal. In one or more example methods, performing the discovery process comprises receiving S101B a second discovery signal from the relay WD. The discovery signal may be indicative of a presence and identity of the device transmitting the discovery signal.

In one or more example methods, performing the discovery process comprises receiving S101C a first discovery response signal from the relay WD. In one or more example methods, performing the discovery process comprises transmitting S101D a second discovery response signal to the relay WD.

In one or more example methods, such as when the remote WD has had an established sidelink connection with a first relay WD and loses the sidelink connection with the first relay WD, the method may comprise performing S101A the discovery process for detecting a second relay WD configured to relay communication between the remote WD and the network node. In one or more example methods, the method comprises, upon detecting a second relay WD configured to relay communication between the remote WD and the network node, establishing S102A a sidelink connection with the second relay WD. In one or more example methods, the second relay WD may be the same as the first relay WD. In other words, the remote WD may perform the discovery process to reestablish the sidelink connection with the first relay WD.

In one or more example methods, the remote WD performs S101 the discovery process upon detecting that a received signal strength from the network node is equal to or below a signal strength threshold. When the received signal strength is equal to or below the signal strength threshold the remote WD may perform the discovery process to detect a relay WD having a higher signal strength or better quality than the network node. The signal strength may be measured on one or more reference signals received from the network node and/or one or more WDs.

The method comprises communicating S103, between the remote WD and the network node, at least one relay paging response configuration message configuring the remote WD with a plurality of alternative response paths that can be used when responding to paging. The alternative response paths comprise responding directly to the network node, such as via the Uu interface, or responding via the relay WD, such as via the PC5 interface. The at least one relay paging response configuration message configuring the remote WD, may herein mean that the at least one relay paging response configuration message provides the remote WD with all the information and/or settings it requires to respond to paging using any of the alternative response paths. In other words, the at least one relay paging response configuration message may comprise the information and/or settings that the remote WD needs to respond to paging using either a direct link to the network node or responding via the relay WD.

In one or more example methods, communicating S103 the at least one relay paging response configuration message comprises communicating S103A the at least one relay paging response configuration message directly, such as via a direct wireless interface, such as the Uu interface, with the network node.

In one or more example methods, communicating S103 the at least one relay paging response configuration message comprises communicating S103B the at least one relay paging response configuration message with the network node via the relay node. In other words, the remote WD may communicate the at least one relay paging response configuration message with the relay node via the sidelink and the relay WD may relay the at least one relay paging response configuration message to the network node via the direct link with the network node, such as via the Uu interface.

In one or more example methods, communicating S103 comprises sending S102A, to the network node, a capability message indicative of the remote WD being configured to communicate with the network node via the relay WD. In one or more example methods, the capability message comprises an indication indicating that the remote WD has an established sidelink connection with the relay WD. In one or more example methods, the capability message comprises an indication indicating that the remote WD will respond to paging via the relay WD. In one or more example methods, the at least one relay paging response configuration message, such as the capability message, comprises an ID, such as a UE ID, identifying the remote WD. In one or more example methods, the at least one relay paging response configuration message, such as the capability message, may comprise a temporary UE ID for identifying the remote WD. In one or more example methods the capability message may comprise an ID, such as a UE ID or a temporary UE ID, identifying the relay WD to which the remote WD has established a sidelink connection. The capability message may be sent to the network node via the direct link or via the sidelink. In one or more example methods, the capability message may be a UE capability Information message, such as an adapted UE capability Information message.

In one or more example methods, communicating S103 comprises receiving S104A, from the network node, a relay configuration to be used when communicating with the network node via the relay WD. The relay configuration may be received in response to sending S102A the capability message to the network node. In one or more example methods, the relay configuration received from the network node may be based on the capability message sent to the network node. The relay configuration may be received from the network node via the direct link or via the sidelink. This step S104A corresponds to the step S3003C of the network node.

In one or more example methods, communicating S103 comprises sending S102B, to the network node, a request to respond to paging via the relay node. In one or more example methods, the request may comprise an indication that the remote WD has an established sidelink connection with the relay WD, which may be identified by a UE ID comprised in the request. The request may further comprise an indication that the remote WD wishes to use the established sidelink for responding to paging from the network node. The indication may be a flag (via sidelink Yes/No) or a new parameter. The request may be sent to the network node via the direct link or via the sidelink.

In one or more example methods, communicating S103 comprises receiving S104B, from the network node, an acknowledgement, ACK, to respond to paging via the relay node. The ACK may be received in response to sending the request to respond to paging via the relay node.

In one or more example methods, the method comprises entering S105 a power efficient state over the established sidelink connection after communicating S103 the at least one relay paging response configuration message. Entering a power efficient mode herein means that a sidelink is established between the relay WD and the remote WD, and that the relay WD is in a dormant mode, such as a non-active mode, on the sidelink. In the power efficient mode, the relay WD may perform sparse monitoring of the sidelink, such as to make sure that the sidelink is still established to the remote WD or to monitor for messages on the sidelink.

The method comprises monitoring S107 for a paging message, intended for the remote WD, directly from the network node. Monitoring for a paging message directly from the network node herein means that the remote WD monitors a direct link, such as a Uu interface, from the network node for the paging message. In one or more example methods, monitoring S107 for a paging message from the network node comprises monitoring S107A a direct link connection with the network node, such as the radio interface, such as the Uu interface, between the remote WD and the network node.

In one or more example methods, the method comprises determining S108, based on the relay paging response configuration message, a response path for transmitting the paging response to the network node. The response path may be one of the plurality of alternative response paths indicated in the relay paging response configuration message. The alternative response paths comprise responding directly to the network node or responding via the relay WD. In one or more example methods, determining S108 may comprise determining the response path for transmitting the paging response to the network node based on channel conditions between the remote WD and the network node and/or the remote node and the relay WD, such as based on a signal strength of the respective channel, such as based on a received signal strength at the remote WD for the respective channel. In one or more example methods, determining S108 may comprise determining S108A to transmit the paging response to the network node via the relay node, such as via the sidelink. In one or more example methods, determining S108 may comprise determining S108A to transmit the paging response to the network node via the relay node, such as via the sidelink, upon the channel conditions being better for the channel between the remote WD and the relay WD than for the channel between the remote WD and the network node. In one or more example methods, determining S108 may comprise determining S108A to transmit the paging response to the network node via the relay node, such as via the sidelink, upon the signal strength for the channel between the remote WD and the relay WD being higher than the signal strength for the channel between the remote WD and the network node. In one or more example methods, determining S108 may comprise determining S108A to transmit the paging response to the network node via the relay node, such as via the sidelink, upon the signal strength from the network node being equal to or below a signal strength threshold. In one or more example methods, determining S108 may comprise determining S108B to transmit the paging response to the network node via the Uu interface, such as via a direct link. In one or more example methods, determining S108 may comprise determining S108B to transmit the paging response to the network node via the Uu interface, such as via a direct link, upon the signal strength for the channel between the remote WD and the relay WD being lower than the signal strength for the channel between the remote WD and the network node. In one or more example methods, determining S108 may comprise determining S108B to transmit the paging response to the network node via the Uu interface, such as via a direct link, upon the signal strength from the network node being above the signal strength threshold.

In one or more example methods, such as upon determining S108A to transmit the paging response to the network node via the relay node, the method comprises, in response to detecting the paging message from the network node, such as a paging message comprising the ID of the remote WD, activating S109 the sidelink connection with the relay WD. Activating the sidelink connection can herein be seen as the remote WD leaving the power efficient state to enter an active state, in which the remote WD can communicate with the relay WD over the sidelink connection. Activating the sidelink connection allows the remote WD to send a paging response to the network node via the sidelink connection to the relay node, so that the relay node can relay the paging response to the network node. In one or more example methods, as soon as the remote WD receives a paging, the remote WD knows, such as based on the relay paging response configuration, that the remote WD can switch to the side-link to transmit the paging response to the network node.

The method comprises, upon detecting the paging message from the network node, transmitting S111 the paging response, to be relayed to the network node, to the relay WD over the sidelink connection, such as over the PC5 interface. In one or more example methods, transmitting S111 is performed upon determining S108A to transmit the paging response to the network node via the relay node. In one or more example methods, the paging response comprises the ID identifying the remote WD. The ID allows the network node to determine which remote WD the paging response was sent from. While the remote WD responds to the paging message via the sidelink, the direct link, such as the Uu interface, remains in RRC IDLE state.

In one or more example methods, the method comprises communicating S113 data with the network node via the relay WD. After the remote WD sent the response to the paging message to the network node via the relay WD, the remote WD may continue communicating data with the network node via the relay WD.

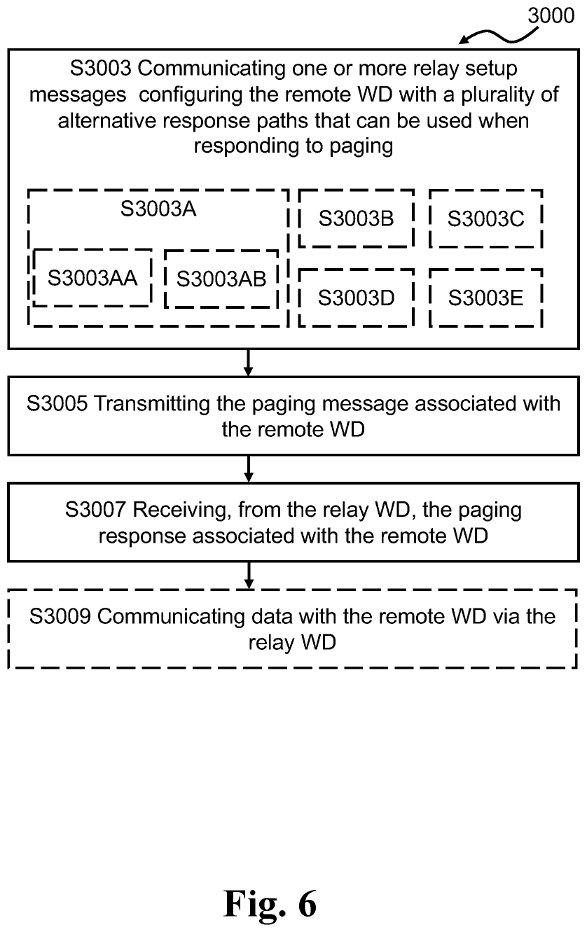

FIG. 6 shows a flow diagram of an example method 3000, performed in a network node according to the disclosure, for establishing communication between a remote wireless device, WD, and the network node. The network node is the network node disclosed herein, such as the network node 400 in FIGS. 1, 2, 3 and 9. The remote WD is camping on the network, such as on the network node.

The method 3000 comprises communicating S3003 one or more relay paging response configuration messages configuring the remote WD with a plurality of alternative response paths that can be used when responding to paging. The alternative response paths comprise responding directly to the network node or responding via the relay WD.

In one or more example methods, communicating S3003 the one or more relay paging response configuration messages comprises receiving S3003A a capability message of the remote WD and/or the relay WD indicative of the remote WD being configured to communicate with the network node via the relay WD. In one or more example methods, the at least one relay paging response configuration message comprises a remote WD identifier, ID, identifying the remote WD. In one or more example methods, the at least one relay paging response configuration message comprises a relay WD ID identifying the relay WD. This step S3003 corresponds to the step S102A of the remote WD and/or S203A of the relay WD.

In one or more example methods, receiving the capability setup message comprises receiving S3003AA, from the remote WD, the capability message of the remote WD. In other words, the network node may receive the capability message directly from the remote WD via the direct link, such as via the Uu interface.

In one or more example methods, receiving the capability setup message comprises receiving S3003AB, from the relay network node, the capability message of the remote WD and/or the relay WD. In other words, the network node may receive the capability message from the remote WD relayed via the relay WD. In one or more example methods, the relay WD may only relay the capability message of the remote WD. In one or more example methods, the relay WD may transmit its own capability message to the network node. In one or more example methods, the capability message of the remote WD and/or the relay WD comprises an indication indicating that the relay WD has an established sidelink connection with the remote WD or vice versa.

In one or more example methods, communicating S3003 comprises transmitting S3003B, to the relay WD, a paging monitoring request message requesting the relay WD to monitor paging occasions for the remote WD. In one or more example methods, the paging monitoring request message is indicative of configured paging occasions for the remote WD. In one or more example methods, the paging monitoring request message comprises a remote WD ID identifying the remote WD. The ID of the remote WD allows the relay WD to identify which remote WD it is requested to monitor paging for. In one or more example methods, the relay WD may calculate the paging occasion, such as the timing of the paging occasion, using the ID of the remote WD. To listen to potential paging for the remote WD the relay WD may have to determine a timing for the paging occasions for the remote WD. The timing for paging occasions can be based on the temporary UE ID used in the network to identify the WD. The temporary UE ID may be a 5G Temporary Mobile Subscriber Identity (5G-S-TMSI). The relay WD may thus use the ID of the remote WD, such as the temporary UE ID of the remote WD, to determine the timing of the paging occasions for the remote WD. In one or more examples, such as when the network requests the relay WD to monitor multiple paging occasions (such as for multiple remote WDs), the paging monitoring request may comprise more than one IDs, such as an ID for each of the remote WDs that the relay WD is requested to monitor. This step S3003B corresponds to step S203B of the relay WD.

In one or more example methods, communicating S3003 comprises sending S3003C, to the remote WD, a relay configuration to be used when communicating with the network node via the relay WD. The relay configuration may be transmitted in response to receiving S102A the capability message from the remote WD and/or the relay WD. In one or more example methods, the relay configuration may be determined by the network node based on the capability message received from the remote WD and/or the relay WD. The relay configuration may be sent to the remote WD via the direct link or via the sidelink. This step S3003C corresponds to the step S104A of the remote WD.

In one or more example methods, communicating S3003 comprises receiving S3003D, from the remote WD, a request to respond to paging via the relay node. This step S3003D corresponds to the step S102B of the remote WD.

In one or more example methods, communicating S3003 comprises sending S3003E, to the remote WD, an acknowledgement, ACK, to respond to paging via the relay node. This step S3003E corresponds to the step S104B of the remote WD.

In one or more example methods, transmitting S3003B comprises transmitting the paging monitoring request message via wake-up signaling. In one or more example methods, transmitting S3003B comprises transmitting the paging monitoring request message via Physical Downlink Control Chanel, PDCCH, signaling. In one or more example methods, transmitting S3003B comprises transmitting the paging monitoring request message via RRC signaling. This step S3003B corresponds to step S203B of the relay WD.

The method 3000 comprises transmitting S3005 the paging message associated with the remote WD. The paging message may be transmitted via the direct link to the remote WD, such as via the Uu interface.

The method 3000 comprises receiving S3007, from the relay WD, the paging response associated with the remote WD. The relay WD may relay the paging response from the remote WD to the network node. This step S3007 corresponds to the step S213 of the relay WD.

In one or more example methods, the method 3000 comprises communicating S3009 data with the remote WD via the relay WD. This step S3009 corresponds to the step S113 of the remote WD and step S217 of the relay WD.

In one or more example methods, the network node is a radio network node.

In one or more example methods, the network node is a core network node configured to communicate with the remote WD and/or the relay WD via one or more radio network nodes.

FIG. 7 shows a block diagram of an example relay WD 300A according to the disclosure. The relay WD 300A comprises memory circuitry 301, processor circuitry 302, and a wireless interface 303. The relay WD 300A may be configured to perform any of the methods disclosed in FIG. 4. In other words, the relay WD 300 may be configured for establishing communication between a remote WD and a network node. The relay WD has an established sidelink connection with the remote WD.

The relay WD 300A is configured to communicate with a network node, such as the network node 400 and with the remote WD 300, using a wireless communication system. The relay wireless device 300A is configured to communicate with the network node via a direct link, such as via the Uu interface. The relay WD 300A is configured to communicate with the remote WD via a sidelink, such as via the PC5 interface.

The relay wireless device 300A is configured to communicate (such as via the wireless interface 303A), between the relay WD and the network node, at least one relay paging response configuration message configuring the remote WD with a plurality of alternative response paths that can be used when responding to paging. The alternative response paths comprise responding directly to the network node or responding via the relay WD.

The relay wireless device 300A is configured to monitor (such as via the wireless interface 303A, and/or using the processor circuitry 302A) a paging occasion for a paging message of the remote WD from the network node.

The relay wireless device 300A is configured to, upon detecting the paging message from the network node, activate (such as using the wireless interface 303A, and/or using the processor circuitry 302A) the sidelink connection with the remote WD.

The relay wireless device 300A is configured to, upon receiving the paging message, relaying (such as via the wireless interface 303A, and/or the processor circuitry 302A) the paging response received from the remote WD to the network node.

The wireless interface 303A is configured for wireless communications via a wireless communication system, such as a 3GPP system, such as a 3GPP system supporting one or more of: New Radio, NR, Narrow-band IoT, NB-IoT, Long Term Evolution (LTE), and LTE-enhanced Machine Type Communication, LTE-M, millimeter-wave communications, such as millimeter-wave communications in licensed/unlicensed bands, such as device-to-device millimeter-wave communications in licensed/unlicensed bands.

The relay wireless device 300A is optionally configured to perform any of the operations disclosed in FIG. 4 (such as any one or more of S201, S201A, S201B, S202, S203, S203A, S203B, S205, S209, S211, S213, S213A, S213B, S217). The operations of the relay wireless device 300A may be embodied in the form of executable logic routines (for example, lines of code, software programs, etc.) that are stored on a non-transitory computer readable medium (for example, memory circuitry 301A) and are executed by processor circuitry 302A).

Furthermore, the operations of the relay wireless device 300A may be considered a method that the relay wireless device 300A is configured to carry out. Also, while the described functions and operations may be implemented in software, such functionality may also be carried out via dedicated hardware or firmware, or some combination of hardware, firmware and/or software.

Memory circuitry 301A may be one or more of a buffer, a flash memory, a hard drive, a removable media, a volatile memory, a non-volatile memory, a random access memory (RAM), or another suitable device. In a typical arrangement, memory circuitry 301A may include a non-volatile memory for long term data storage and a volatile memory that functions as system memory for processor circuitry 302A. Memory circuitry 301A may exchange data with processor circuitry 302A over a data bus. Control lines and an address bus between memory circuitry 301A and processor circuitry 302A also may be present (not shown in FIG. 7). Memory circuitry 301A is considered a non-transitory computer readable medium.

Memory circuitry 301A may be configured to store information (such as information indicative of the relay configuration, the paging monitoring request, and/or the ID of the remote WD) in a part of the memory.

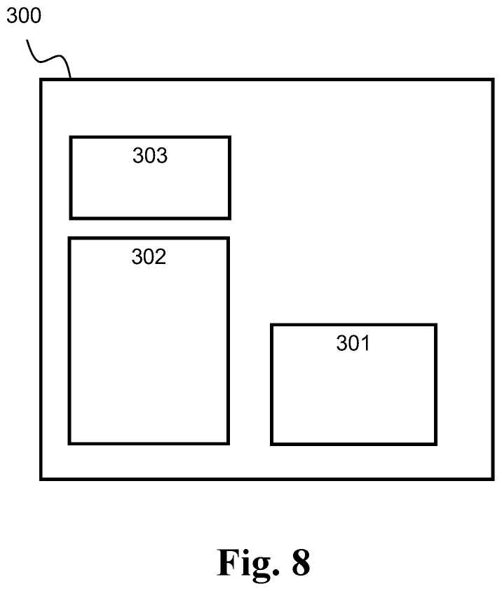

FIG. 8 shows a block diagram of an example remote wireless device 300 according to the disclosure. The remote wireless device 300 comprises memory circuitry 301, processor circuitry 302, and a wireless interface 303. The remote wireless device 300 may be configured to perform any of the methods disclosed in FIG. 5. In other words, the remote wireless device 300 may be configured for establishing communication between the remote WD and a network node.

The remote WD is camping on the network, such as on the network node, and has an established sidelink connection with a relay WD

The remote wireless device 300 is configured to communicate (such as via the wireless interface 303) between the remote WD and the network node, at least one relay paging response configuration message configuring the remote WD with a plurality of alternative response paths that can be used when responding to paging. The alternative response paths comprise responding directly to the network node or responding via the relay WD.

The remote wireless device 300 is configured to monitor (such as via the wireless interface 303 and/or the processor circuitry 302) for a paging message directly from the network node.

The remote wireless device 300 is configured, upon detecting the paging message from the network node, to transmit (such as via the wireless interface 303) the paging response to be relayed to the network node to the relay WD over the sidelink connection.

The wireless interface 303 is configured for wireless communications via a wireless communication system, such as a 3GPP system, such as a 3GPP system supporting one or more of: New Radio, NR, Narrow-band IoT, NB-IoT, Long Term Evolution (LTE), and LTE-enhanced Machine Type Communication, LTE-M, millimeter-wave communications, such as millimeter-wave communications in licensed/unlicensed bands, such as device-to-device millimeter-wave communications in licensed/unlicensed bands.

The remote wireless device 300 is optionally configured to perform any of the operations disclosed in FIG. 5 (such as any one or more of S101, S101A, S101B, S102A, S102B, S103, S103A, S103B, S104A, S104B, S105, S107, S107A, S109, S111, S113). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the remote wireless device 300 may be considered a method that the remote wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 8). Memory circuitry 301 is considered a non-transitory computer readable medium.

Memory circuitry 301 may be configured to store information (such as information indicative of a relay configuration, a paging message and/or a capability of the remote WD) in a part of the memory.

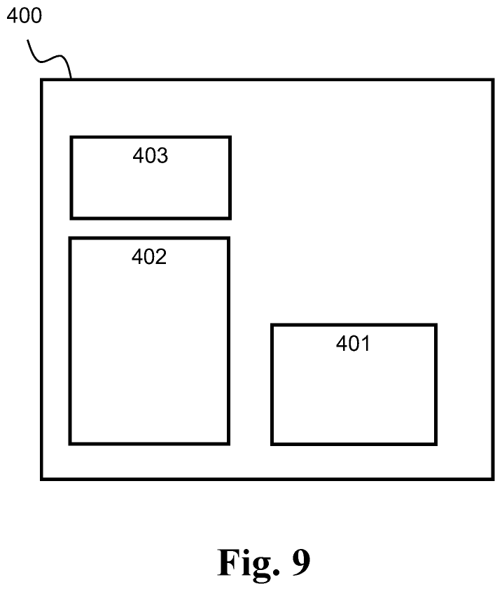

FIG. 9 shows a block diagram of an example network node 800 according to the disclosure. The network node 800 comprises memory circuitry 401, processor circuitry 402, and a wireless interface 403. The network node 800 may be configured to perform any of the methods disclosed in FIG. 6. In other words, the network node 800 may be configured for establishing communication between a remote wireless device, WD, and the network node. In one or more examples, the network node 800 is a radio network node 400. In one or more example methods, the network node 800 is a core network node 600, the core network node 600 communicating with the WD 300 via the radio network node 400.

The network node 800 is configured to communicate with a user equipment, such as the user equipment node disclosed herein, using a wireless communication system.

The network node 800 is configured to communicate (such as via the wireless interface 403) one or more relay paging response configuration messages configuring the remote WD with a plurality of alternative response paths that can be used when responding to paging. The alternative response paths comprise responding directly to the network node or responding via the relay WD,

The network node 800 is configured to transmit (such as via the wireless interface 403) the paging message associated with the remote WD.

The network node 800 is configured to receive (such as via the wireless interface 403), from the relay WD, the paging response associated with the remote WD.

The wireless interface 403 is configured for wireless communications via a wireless communication system, such as a 3GPP system, such as a 3GPP system supporting one or more of: New Radio, NR, Narrow-band IoT, NB-IoT, Long Term Evolution (LTE), and LTE-enhanced Machine Type Communication, LTE-M, millimeter-wave communications, such as millimeter-wave communications in licensed/unlicensed bands, such as device-to-device millimeter-wave communications in licensed/unlicensed bands.

Processor circuitry 402 is optionally configured to perform any of the operations disclosed in FIG. 6 (such as any one or more of S3003, S3003A, S3003AA, S3003AB, S3003B, S3003C, S3003D, S3003E, S3005, S3007, S3009). The operations of the network node 800 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 800 may be considered a method that the network node 800 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 9). Memory circuitry 401 is considered a non-transitory computer readable medium.

Memory circuitry 401 may be configured to store information (such as information related to capabilities of the remote WD and/or the relay WD, and/or a paging monitoring configuration) in a part of the memory.

Examples of methods and products (wireless devices and network node) according to the disclosure are set out in the following items:
Item 1. A method performed by a relay wireless device, WD, for establishing communication between a remote WD and a network node, wherein the relay WD has an established sidelink connection with the remote WD, wherein the method comprises:
   communicating (S203), between the relay WD and the network node, at least one relay paging response configuration message configuring the remote WD with a plurality of alternative response paths that can be used when responding to paging, wherein the alternative response paths comprise responding directly to the network node or responding via the relay WD,
   monitoring (S209) a paging occasion for a paging message of the remote WD from the network node,
   upon detecting the paging message from the network node, activating (S211) the sidelink connection with the remote WD, and
   upon receiving the paging message, relaying (S213) the paging response received from the remote WD to the network node.
Item 2. The method according to Item 2, wherein relaying (S213) comprises:
   receiving (S213A) the paging response to be relayed to the network node from the remote WD via the sidelink connection, and
   transmitting (S213B), to the network node, the paging response received from the remote WD.
Item 3. The method according to any of the Items 1 to 2, wherein monitoring (S209) the paging occasion comprises monitoring one or more of:
   a first paging occasion configured for the remote WD, and
   a second paging occasion configured for the relay WD.
Item 4. The method according to any of the Items 1 to 3, wherein communicating (S203) comprises transmitting (S203A) a capability message to the network node.
Item 5. The method according to Item 4, wherein the capability message comprises an indication indicating that the relay WD has an established sidelink connection with the remote WD.
Item 6. The method according to any one of the Items 1 to 5, wherein the relay paging response configuration message comprises an identifier, ID, identifying the remote WD.
Item 7. The method according to any of the Items 1 to 6, wherein communicating (S203) comprises:
   receiving (S203B), from the network node, a paging monitoring request message requesting the relay WD to monitor paging occasions for the remote WD.
Item 8. The method according to Item 7, wherein the paging monitoring request message is indicative of configured paging occasions for the remote WD.
Item 9. The method according to any of Items 7 to 8, wherein receiving (S203B) comprises receiving the paging monitoring request message via one or more of:
   wake-up signaling,
   Physical Downlink Control Chanel, PDCCH, signaling, and
   Radio Resource Control, RRC, signaling.
Item 10. The method according to any of the Items 7 to 9, wherein the paging monitoring request message indicative of configured paging occasions for the remote WD comprises an identifier, ID, identifying the remote WD.
Item 11. The method according to any of the Items 1 to 10, wherein the method comprises:
   entering (S205) a power efficient state over the established sidelink connection, after communicating (S203) the at least one relay paging response configuration message.
Item 12. The method according to any of the Items 1 to 11, wherein the method comprises:
   performing (S201) a discovery process for detecting a remote WD requesting a relaying of communication between the remote WD and the network node, and
   upon detecting a remote WD requesting a relaying of communication, establishing (S202) a sidelink connection with the second remote WD.
Item 13. The method according to Item 12, wherein performing (S201) the discovery process comprises one or more of:
   transmitting (S201A) a first discovery signal, and
   receiving (S201B) a second discovery signal from the second remote WD.
Item 14. The method according to any of the Items 1 to 13, wherein the method comprises:
   relaying (S217) data between the remote WD and the network node.
Item 15. A method performed by a remote wireless device, WD, for establishing communication between the remote WD and a network node, wherein the remote WD is camping on the network and has an established sidelink connection with a relay WD, wherein the method comprises:
   communicating (S103), between the remote WD and the network node, at least one relay paging response configuration message configuring the remote WD with a plurality of alternative response paths that can be used when responding to paging, wherein the alternative response paths comprise responding directly to the network node or responding via the relay WD,
   monitoring (S107) for a paging message directly from the network node, and
   upon detecting the paging message from the network node, transmitting (S111) the paging response to be relayed to the network node to the relay WD over the sidelink connection.
Item 16. The method according to Item 15, wherein the method comprises:
   entering (S105) a power efficient state over the established sidelink connection after communicating (S103) the at least one relay paging response configuration message.
Item 17. The method according to Item 15 or 16, wherein the method comprises:
   in response to detecting the paging message from the network node, activating (S109) the sidelink connection with the relay WD.
Item 18. The method according to any of the previous Items 15 to 17, wherein monitoring (S107) for a paging message from the network node comprises monitoring (S107A) a direct link connection with the network node.
Item 19. The method according to any of the previous Items 15 to 18, wherein communicating (S103) the at least one relay paging response configuration message comprises communicating (S103A) the at least one relay paging response configuration message directly with the network node.
Item 20. The method according to any of the previous Items 15 to 19, wherein communicating (S103) the at least one relay paging response configuration message comprises communicating (S103B) the at least one relay paging response configuration message with the network node via the relay node.
Item 21. The method according to any of the previous Items 15 to 20, wherein communicating (S103) comprises sending (S102A), to the network node, a capability message indicative of the remote WD being configured to communicate with the network node via the relay WD.
Item 22. The method according to any of the previous Items 15 to 21, wherein communicating (S103) comprises receiving (S104A), from the network node, a relay configuration to be used when communicating with the network node via the relay WD.
Item 23. The method according to any of the Items 15 to 20, wherein communicating (S103) comprises sending (S102B), to the network node, a request to respond to paging via the relay node.
Item 24. The method according to previous Item 23, wherein communicating (S103) comprises receiving (S104B), from the network node, an acknowledgement, ACK, to respond to paging via the relay node.
Item 25. The method according to any of the previous Items 15 to 24, wherein the paging response comprises an identifier, ID, identifying the remote WD.
Item 26. The method according to any of the previous Items 15 to 25, wherein the method comprises:
   performing (S101) a discovery process for detecting a second relay WD configured to relay communication between the remote WD and the network node, and
   upon detecting the second relay WD, establishing (S103) a sidelink connection with the second relay WD.
Item 27. The method according to Item 26, wherein performing (S101) the discovery process comprises one or more of:
   transmitting (S101A) a first discovery signal, and
   receiving (S101B) a second discovery signal from the relay WD.
Item 28. The method according to any one of Items 26 to 27, wherein the remote WD performs (S101) the discovery process upon detecting that a received signal strength from the network node is equal to or below a signal strength threshold.
Item 29. The method according to any one of the Items 15 to 28, wherein the method comprises:
   communicating (S113) data with the network node via the relay WD.
Item 30. The method according to any one of the Items 15 to 29, wherein the method comprises:
   determining (S108), based on the relay paging response configuration message, a response path out of the plurality of alternative response paths indicated in the relay paging response configuration for transmitting the paging response to the network node.
Item 31. The method according to Item 30, wherein the transmitting (S211) is performed upon determining, based on the relay paging response configuration message, to transmit the paging response to the network node via the relay node.
Item 32. A method, performed in a network node, for establishing communication between a remote wireless device, WD, and the network node, wherein the remote WD is camping on the network, the method comprising:
   communicating (S3003) one or more relay paging response configuration messages configuring the remote WD with a plurality of alternative response paths that can be used when responding to paging, wherein the alternative response paths comprise responding directly to the network node or responding via the relay WD,
   transmitting (S3005) the paging message associated with the remote WD, and
   receiving (S3007), from the relay WD, the paging response associated with the remote WD.
Item 33. The method according to Item 32, wherein communicating (S3003) the one or more relay paging response configuration messages comprise receiving (S3003A) a capability message of the remote WD and/or the relay WD indicative of the remote WD being configured to communicate with the network node via the relay WD.
Item 34. The method according to Item 33, wherein receiving the capability setup message comprises receiving (S3003AA), from the remote WD, the capability message of the remote WD.
Item 35. The method according to Item 33 or 34, wherein receiving the capability setup message comprises receiving (S3003AB), from the relay network node, the capability message of the remote WD and/or the relay WD.
Item 36. The method according to any of the Items 33 to 35, wherein the capability message of the remote WD and/or the relay WD comprises an indication indicating that the relay WD has an established sidelink connection with the remote WD.
Item 37. The method according to any of the Items 32 to 36, wherein communicating (S3003) comprises:
   transmitting (S3003B), to the relay WD, a paging monitoring request message requesting the relay WD to monitor paging occasions for the remote WD.
Item 38. The method according to Item 37, wherein the paging monitoring request message is indicative of configured paging occasions for the remote WD.
Item 39. The method according to any of the Items 36, wherein the paging monitoring request message comprises a remote WD ID identifying the remote WD.
Item 40. The method according to any of the Items 32 to 39, wherein communicating (S3003) comprises:
   sending (S3003C), to the remote WD, a relay configuration to be used when communicating with the network node via the relay WD.
Item 41. The method according to any of the Items 32 to 40, wherein communicating (S3003) comprises receiving (S3003D), from the remote WD, a request to respond to paging via the relay node.
Item 42. The method according to Item 41, wherein communicating (S3003) comprises sending (S3003E), to the remote WD, an acknowledgement, ACK, to respond to paging via the relay node.
Item 43. The method according to any of Item 32 to 42, wherein the at least one relay paging response configuration message comprises one or more of:
   a remote WD identifier, ID, identifying the remote WD, and
   a relay WD ID identifying the relay WD.
Item 44. The method according to any of the Items 37 to 39, wherein transmitting (S3003B) comprises transmitting the paging monitoring request message via one or more of:
   wake-up signaling,
   Physical Downlink Control Chanel, PDCCH, signaling, and
   Radio Resource Control, RRC, signaling.
Item 45. The method according to any of the Items 32 to 44, wherein the method comprises:
   communicating (S3009) data with the remote WD via the relay WD.
Item 46. The method according to any of the Items 32-45, wherein the network node is a radio network node.
Item 47. The method according to any of the Items 32-45, wherein the network node is a core network node configured to communicate with the remote WD and/or the relay WD via one or more radio network nodes.
Item 48. A relay wireless device comprising memory circuitry, processor circuitry, and a wireless interface, wherein the relay wireless device is configured to perform any of the methods according to any of Items 1-14.
Item 49. A remote wireless device comprising memory circuitry, processor circuitry, and a wireless interface, wherein the remote wireless device is configured to perform any of the methods according to any of Items 15-31.
Item 50. A network node comprising memory circuitry, processor circuitry, and a wireless interface, wherein the network node is configured to perform any of the methods according to any of Items 32-47.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-9 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a remote wireless device (WD) for establishing communication between the remote WD and a network node, wherein the remote WD is camping on the network and has an established sidelink connection with a relay WD, wherein the method comprises:
communicating, between the remote WD and the network node, at least one relay paging response configuration message configuring the remote WD with a plurality of alternative response paths that can be used when responding to paging, wherein the alternative response paths comprise responding directly to the network node or responding via the relay WD, the relay paging response configuration message comprising information and/or settings required by the remote WD to respond to paging using any of the alternative response paths,
monitoring for a paging message intended for the remote WD directly from the network node, and
upon detecting the paging message intended for the remote WD from the network node, transmitting the paging response to be relayed to the network node to the relay WD over the sidelink connection.

2. The method according to claim 1, wherein the method comprises:
entering a power efficient state over the established sidelink connection after communicating the at least one relay paging response configuration message.

3. The method according to claim 1, wherein the method comprises:
in response to detecting the paging message from the network node, activating the sidelink connection with the relay WD.

4. The method according to claim 1, wherein monitoring for a paging message from the network node comprises monitoring a direct link connection with the network node.

5. The method according to claim 1, wherein communicating the at least one relay paging response configuration message comprises communicating the at least one relay paging response configuration message directly with the network node.

6. The method according to claim 1, wherein communicating the at least one relay paging response configuration message comprises communicating the at least one relay paging response configuration message with the network node via the relay node.

7-17. (canceled)

18. A method performed by a relay wireless device (WD) for establishing communication between a remote WD and a network node, wherein the relay WD has an established sidelink connection with the remote WD, wherein the method comprises:
communicating, between the relay WD and the network node, at least one relay paging response configuration message configuring the remote WD with a plurality of alternative response paths that can be used when responding to paging, wherein the alternative response paths comprise responding directly to the network node or responding via the relay WD,
monitoring a paging occasion for a paging message of the remote WD from the network node,
upon detecting the paging message from the network node, activating the sidelink connection with the remote WD, and
upon receiving the paging message, relaying the paging response received from the remote WD to the network node.

19. The method according to claim 18, wherein relaying comprises:
receiving the paging response to be relayed to the network node from the remote WD via the sidelink connection, and
transmitting, to the network node, the paging response received from the remote WD.

20-31. (canceled)

32. A method, performed in a network node, for establishing communication between a remote wireless device (WD) and the network node, wherein the remote WD is camping on the network, the method comprising:
communicating one or more relay paging response configuration messages configuring the remote WD with a plurality of alternative response paths that can be used when responding to paging, wherein the alternative response paths comprise responding directly to the network node or responding via the relay WD,
transmitting the paging message associated with the remote WD, and
receiving, from the relay WD, the paging response associated with the remote WD.

33-50. (canceled)

51. The method according to claim 18, wherein monitoring the paging occasion comprises monitoring one or more of:
a first paging occasion configured for the remote WD, and
a second paging occasion configured for the relay WD.

52. The method according to claim 18, wherein communicating comprises transmitting a capability message to the network node, wherein the capability message comprises an indication indicating that the relay WD has an established sidelink connection with the remote WD.

53. The method according to claim 52, wherein the relay paging response configuration message comprises an identifier (ID) identifying the remote WD.

54. The method according to claim 18, wherein the relay paging response configuration message comprises an identifier (ID) identifying the remote WD.

55. The method according to claim 18, wherein communicating comprises:
receiving, from the network node, a paging monitoring request message requesting the relay WD to monitor paging occasions for the remote WD.

56. The method according to claim 55, wherein the paging monitoring request message is indicative of configured paging occasions for the remote WD.

57. The method according to claim 55, wherein receiving comprises receiving the paging monitoring request message via one or more of:
wake-up signaling,
Physical Downlink Control Chanel (PDCCH) signaling, and
Radio Resource Control (RRC) signaling.

58. The method according to claim 55, wherein the paging monitoring request message indicative of configured paging occasions for the remote WD comprises an identifier (ID) identifying the remote WD.

59. The method according to claim 18, wherein the method comprises:
entering a power efficient state over the established sidelink connection, after communicating the at least one relay paging response configuration message.

60. The method according to claim 59, wherein performing the discovery process comprises one or more of:
transmitting a first discovery signal, and
receiving a second discovery signal from the second remote WD.

61. The method according to claim 18, wherein the method comprises:
relaying data between the remote WD and the network node.
